(19) United States
(12) Patent Application Publication
(10) Pub. No.: US 2022/0129971 A1
(43) Pub. Date: Apr. 28, 2022

(54) CLOTHING INDICATION SYSTEM, INFORMATION PROCESSING APPARATUS, AND CLOTHING INDICATION METHOD

(71) Applicants: TOYOTA JIDOSHA KABUSHIKI KAISHA, Toyota-shi (JP); DENSO CORPORATION, Kariya-city (JP)

(72) Inventors: Yurika TANAKA, Yokosuka-shi (JP); Shoji SAKAMOTO, Ichikawa-shi (JP); Kenichi YAMADA, Nisshin-shi (JP); Yuko MIZUNO, Nagoya-shi (JP); Hiromitsu FUJII, Kariya-shi (JP); Katsuhiro OHARA, Kariya-city (JP)

(73) Assignees: TOYOTA JIDOSHA KABUSHIKI KAISHA, Toyota-shi (JP); DENSO CORPORATION, Kariya-city (JP)

(21) Appl. No.: 17/509,968

(22) Filed: Oct. 25, 2021

(30) Foreign Application Priority Data
Oct. 23, 2020 (JP) 2020-178452

(51) Int. Cl. G06Q 30/06; G06K 9/00; H04W 4/80; H04W 4/029; H04W 4/33

(52) U.S. Cl. CPC G06Q 30/0639; G06K 9/00362; H04W 4/33; H04W 4/80; H04W 4/029; G06K 9/00778

(57) ABSTRACT

A clothing indication system includes a first acquisition interface, a plurality of indicators, and an information processing apparatus. The first acquisition interface is configured to acquire body size information indicating a body size of a user. The plurality of indicators is provided in one-to-one correspondence with a plurality of clothing items displayed in a shop and is configured to indicate some clothing items selected from among the plurality of clothing items in a manner such that the selected clothing items are distinguishable from other clothing items. The information processing apparatus is configured to select the clothing items to be indicated by the plurality of indicators based on the body size information for the user.

### CROSS-REFERENCE TO RELATED APPLICATION

This application claims priority to Japanese Patent Application No. 2020-178452, filed on Oct. 23, 2020, the entire contents of which are incorporated herein by reference.

### TECHNICAL FIELD

The present disclosure relates to a clothing indication system, an information processing apparatus, and a clothing indication method.

### BACKGROUND

In order to assist in selecting clothing, systems have been proposed by which product information, including measurements to which the clothing fits, is prestored in a database and whether the clothing will fit the measurements of users is determined (for example, Patent Literature 1). For example, in such a system, a user can read a product identification code on a product tag attached to a clothing item in a shop and download product information for the clothing item from the database using their information terminal. The information terminal provides a simulation of the user trying on the clothing item and displays a determination result including whether the clothing item fits the body of the user.

### CITATION LIST

### Patent Literature

PTL 1: JP 2003-186965 A

### SUMMARY

In actual shops, it can be time-consuming or effort-consuming and therefore burdensome for shoppers to find clothing that fits their sizes from among many clothing items displayed in the shop.

It would be helpful to provide a clothing indication system, an information processing apparatus, and a clothing indication method that enable a user to easily find clothing items that will fit the body size of the user from among many clothing items.

A clothing indication system according to an embodiment of the present disclosure includes a first acquisition interface, a plurality of indicators, and an information processing apparatus. The first acquisition interface is configured to acquire body size information indicating a body size of a user. The plurality of indicators is provided in one-to-one correspondence with a plurality of clothing items displayed in a shop and is configured to indicate some clothing items selected from among the plurality of clothing items in a manner such that the selected clothing items are distinguishable from other clothing items. The information processing apparatus selects the clothing items to be indicated by the plurality of indicators based on the body size information for the user.

An information processing apparatus according to an embodiment of the present disclosure includes a communication interface and a controller. The communication interface is configured to receive body size information indicating a body size of a user. The controller selects some clothing items from among a plurality of clothing items displayed in a shop based on the body size information for the user. The controller causes, via the communication interface, a plurality of indicators provided in one-to-one correspondence with the plurality of clothing items to indicate the selected clothing items in a manner such that the selected clothing items are distinguishable from other clothing items.

A clothing indication method according to an embodiment of the present disclosure includes: acquiring body size information indicating a body size of a user; selecting, by an information processing apparatus, some clothing items from among a plurality of clothing items displayed in a shop based on the body size information for the user. The clothing indication method further includes indicating the selected clothing items in a manner such that the selected clothing items are distinguishable from other clothing items using a plurality of indicators provided in one-to-one correspondence with the plurality of clothing items.

According to the present disclosure, a clothing indication system, an information processing apparatus, and a clothing indication method are provided, all of which enable a user to easily find clothing items that fit the body size of the user from among many clothing items displayed in a shop.

### BRIEF DESCRIPTION OF THE DRAWINGS

In the accompanying drawings:

FIG. 1 is a block diagram illustrating a schematic configuration of a clothing indication system according to an embodiment of the present disclosure;

FIG. 2 is a block diagram illustrating a schematic example configuration of an information processing apparatus of FIG. 1;

FIG. 3 is a block diagram illustrating a schematic example configuration of an indicator of FIG. 1;

FIG. 4 illustrates a clothing indication method by the clothing indication system of FIG. 1; and

FIG. 5 is a flowchart illustrating example processing performed by the information processing apparatus.

### DETAILED DESCRIPTION

An embodiment of the present disclosure will be described below, with reference to the drawings. The drawings used in the following description are schematic. Dimensional ratios or the like on the drawings do not necessarily match actual ones.

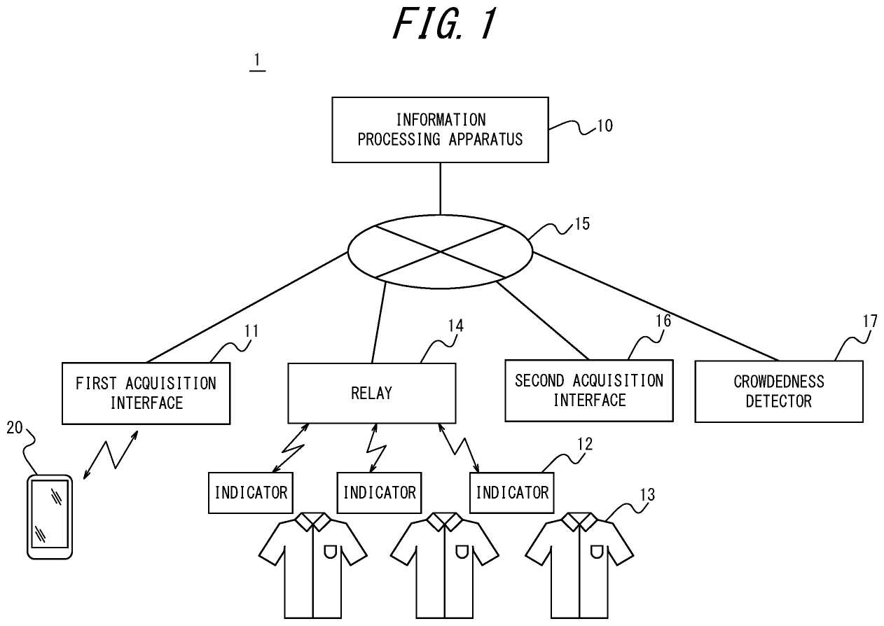

A clothing indication system 1 of the present disclosure is installed in a shop that sells clothing. The clothing refers to clothing as products. In use, the clothing is worn on human bodies. The clothing includes various types of clothing, such as men's clothing, women's clothing, children's clothing, sportswear, or casual wear. As illustrated in FIG. 1, the clothing indication system 1 includes an information processing apparatus 10, a first acquisition interface 11, and indicators 12. By using the indicators 12 attached to clothing items 13, the clothing indication system 1 indicates clothing items 13 in a size that fits a customer in a shop who is also a user of the clothing indication system 1.

The information processing apparatus 10, the first acquisition interface 11, and the indicators 12 are configured to be communicable via a network 15 within the shop. The network 15 may include a wired or wireless Local Area Network (LAN). The indicators 12 may be connected to the network 15 via a relay 14 compliant with wireless communication.

The clothing indication system 1 may further include a second acquisition interface 16 and a crowdedness detector 17, although this is not essential. The second acquisition interface 16 acquires the position of a user in the shop. The crowdedness detector 17 detects the crowdedness in the shop. For example, the crowdedness detector 17 may detect the number of customers in the shop. The second acquisition interface 16 and the crowdedness detector 17 are configured to be communicable with the information processing apparatus 10 via the network 15. A customer who is a user of a service of the clothing indication system 1 is referred to as a “user”, and a customer (including a customer other than a user) who visits the shop is referred to as a “customer” in the present disclosure.

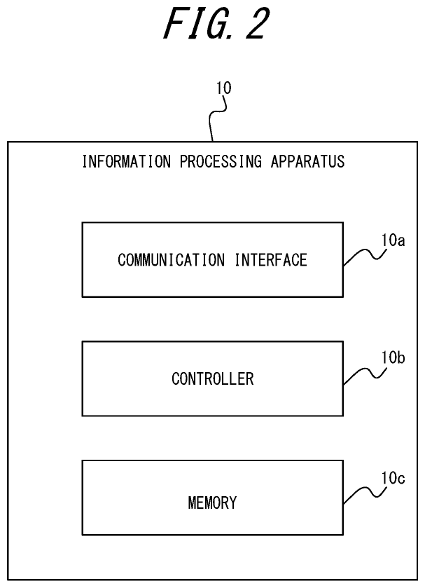

The information processing apparatus 10 manages information for the clothing items 13, that is, products in the shop, and controls the components of the clothing indication system 1 in the shop. As illustrated in FIG. 2, for example, the information processing apparatus 10 is configured with a communication interface 10a, a controller 10b, and a memory 10c. The information processing apparatus 10 is not limited to a single type of hardware, and may be configured by a plurality of types of hardware connected by the network 15. The information processing apparatus 10 can be arranged not only in the shop, but also in a geographically distant place via a communication network.

The communication interface 10a includes a communication module for connection to the network 15. The communication module may include a communication module compliant with various communication standards, such as a wired LAN or wireless LAN. The communication interface 10a may perform processing, such as protocol processing pertaining to information transmission and receipt, modulation of transmitted signals, or demodulation of received signals. The information processing apparatus 10 is connected to the network 15 using the communication interface 10a.

The controller 10b is configured with a single processor or a plurality of processors. In the present disclosure, processors include general purpose processors that execute programmed functions by loading a program, and dedicated processors that are dedicated to specific processing. Dedicated processors may include Digital Signal Processors (DSPs), Application Specific Integrated Circuits (ASICs), Field-Programmable Gate Arrays (FPGAs), or the like. The controller 10b may further include a memory.

The controller 10b controls the operation of the entire information processing apparatus 10. The processing performed by the information processing apparatus 10 can be referred to as the processing performed by the controller 10b. The processing performed by the controller 10b can be referred to as the processing performed by the information processing apparatus 10. The controller 10b can transmit and receive information to and from other components via the communication interface 10a.

For example, the controller 10b can acquire body size information indicating the body size of a user from the information terminal 20 in the possession of the user via the first acquisition interface 11. The controller 10b can acquire positional information indicating the position of the user in the shop from the second acquisition interface 16. The controller 10b can acquire crowdedness information related to the number of customers in the shop from the crowdedness detector 17. The controller 10b can perform various types of processing based on the acquired information. The controller 10b can control the indicators 12 via the relay 14.

The memory 10c stores various types of information required for the processing performed by the information processing apparatus 10. The memory 10c may include a semiconductor storage apparatus, a magnetic storage apparatus, and an optical storage apparatus. Semiconductor storage apparatuses may include memories, such as Read Only Memory (ROM), Random Access Memory (RAM), or flash memory.

The memory 10c stores identification information for the indicators 12 corresponding to the respective clothing items 13 displayed in the shop and clothing size information for the respective clothing items 13. The clothing size information for the clothing items 13 may include information indicating sizes for the clothing items 13, such as S, M, or L. The clothing size information may include information indicating body types to which the clothing fits, such as Y figure, A figure, B figure, or AB figure. The clothing size information may further include more detailed information, such as neck size, shoulder width, chest circumference, waist size, length, sleeve length, or inseam. In addition to the clothing size information, the memory 10c may store product information including targeted age group, pattern, color, material, price, or the like of the products. The product information may further include information that categorizes the clothing, such as casual, classic, street, vintage, or chic.

The first acquisition interface 11 is configured to be communicable with the information terminal 20 in the possession of a user. For example, the first acquisition interface 11 can communicate with the information terminal 20 using a short-range wireless communication technology, such as Bluetooth® (Bluetooth is a registered trademark in Japan, other countries, or both) or Near Field Communication (NFC). A dedicated application compliant with the clothing indication system 1 is installed on the information terminal 20 in the possession of the user. The user registers body size information in the application in advance. The registration of the body size information may be performed by the user directly inputting the body size information, or by using a certain measurement apparatus to read a measurement result of the body size information. The first acquisition interface 11 communicates with the application on the information terminal 20 to thereby acquire the body size information for the user. The first acquisition interface 11 transmits the acquired body size information to the information processing apparatus 10.

The information terminal 20 of a user may only hold identification information for the user, without holding body size information for the user. The body size information for the user may be stored in an external server or the like that is capable of communicating with the information processing apparatus 10 and the information terminal 20 via a communications network. In this case, upon acquiring from the information terminal 20 the identification information for identifying the user, the first acquisition interface 11 may acquire body size information for the user from the server via the communication network based on the identification information.

The indicators 12 indicate some clothing items 13 selected from among the plurality of clothing items 13 in a manner such that they are distinguishable from other clothing items 13. The indicators 12 indicate the existence of the clothing items 13 using light, for example. The indicators 12 may indicate the clothing items 13 using sound, vibration, or the like, instead of light. The indicators 12 are provided in one-to-one correspondence with the clothing items 13. The indicators 12 may be attached to the clothing items 13 in a manner similar to, for example, product tags. The indicators 12 may be attached, for example, to hangers for hanging the clothing items 13.

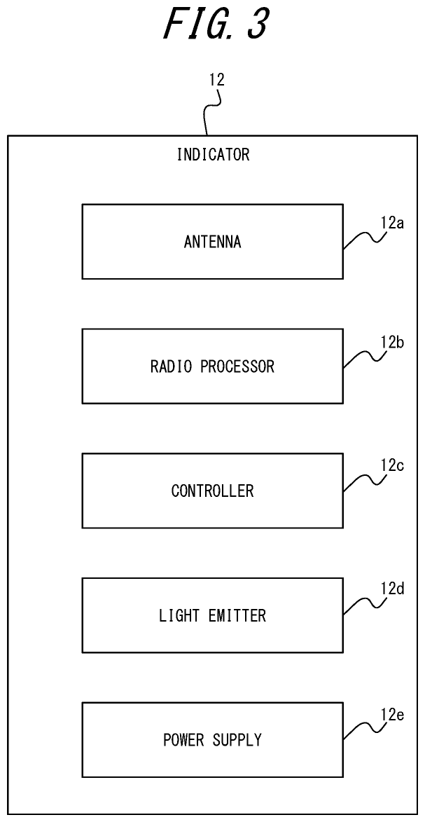

For example, as illustrated in FIG. 3, each indicator 12 may be configured with an antenna 12a, a radio processor 12b, a controller 12c, a light emitter 12d, and a power supply 12e.

The antenna 12a converts electromagnetic waves into electrical signals or electrical signals into electromagnetic waves. The antenna 12a may include an antenna compliant with a communication method between the indicator 12 and the relay 14. Various antennas, such as a coil antenna, a loop antenna, a dipole antenna, or a planar antenna, may be used as the antenna 12a.

The radio processor 12b converts an electrical signal acquired by the antenna 12a into a digital signal. The radio processor 12b converts a digital signal into an electrical signal to be transmitted by the antenna 12a. The radio processor 12b includes a wireless module compliant with a communication method that is used. The wireless module may include a radiofrequency generating circuit, a modulation circuit, a demodulation circuit, an encoding circuit, a decoding circuit, or the like. The wireless module may include a circuit that performs communication protocol processing.

The controller 12c controls the entire indicator 12. The controller 12c is configured with a single processor or a plurality of processors. The controller 12c may also include a memory. In an embodiment, the memory may include identification information distinguishing the indicator 12 from other indicators 12. The identification information that the indicator 12 has is stored in the information processing apparatus 10 in association with the clothing item 13. In a case in which identification information included in a radio signal received matches its own identification information, the controller 12c controls the light emitter 12d to emit light. The controller 12c can cause the light emitter 12d to emit light in different manners. The different manners include different wavelengths or different emission patterns.

The light emitter 12d includes a light emitting device that emits visible light. As the light emitting device, for example, a Light Emitting Diode (LED), an organic Electro-Luminescent (EL) device, or the like may be used. The light emitter 12d may include a plurality of light emitting devices for emitting light of different wavelengths so as to emit light of different wavelengths. The light emission of the light emitter 12d is controlled by the controller 12c.

The power supply 12e supplies electric power to the components of the indicator 12. The power supply 12e may include a battery built in the indicator 12. The indicator 12 does not need to include a power supply 12e. In that case, the indicator 12 may use an electromagnetic wave supplied from the outside as a power source.

Upon acquiring body size information for a user, the information processing apparatus 10 may select clothing items 13 that fit the body size of the user from among the clothing items 13 in the shop. The information processing apparatus 10 transmits signals to indicators 12 provided in correspondence with the selected clothing items 13 so that the selected clothing items 13 are indicated in a manner such that they are distinguishable from other clothing items 13.

The relay 14 relays a signal from the information processing apparatus 10 to be transmitted to an indicator 12. The information processing apparatus 10 and the relay 14 are connected via the network 15. The relay 14 can transmit the signal to the indicator 12 by wireless communication. The relay 14 includes a communication module compliant with a method of wireless communication with the indicator 12. The relay 14 may be able to transmit information to a plurality of indicators 12 within the radio wave range at the same time. The relay 14 may be provided in plurality in the shop. For example, relays 14 may be installed on respective display shelves for the clothing items 13 in the shop. When an indicator 12 does not include the power supply 12e, a relay 14 may supply electric power by transmitting electromagnetic waves to the indicator 12. In a case in which the information processing apparatus 10 is configured to be directly communicable with the indicators 12, no relay 14 is required.

The second acquisition interface 16 acquires the position of a user in the shop. It is not essential to provide the second acquisition interface 16. Various known methods can be used for acquiring the position of the user by the second acquisition interface 16. Thus, a method for acquiring the position of the user is not limited to a particular method.

The second acquisition interface 16 may include, for example, one or more cameras arranged at positions in the shop, such as on the ceiling, to provide a view of the inside of the shop, and a processor. For example, the second acquisition interface 16 can track a user from camera images and always detect the position of the user. Known technology can be used for extracting and tracking humans from camera images.

It is also known that positioning can be performed using signals from beacons or transmitters based on the principle of triangulation. For example, the position of the information terminal 20 can be calculated by installing a transmitter in the shop and measuring the strength or arrival time of the radio waves using the information terminal 20 of the user. The second acquisition interface 16 can acquire, from the information terminal 20 of the user, information on the position calculated by the information terminal 20. In this case, the second acquisition interface 16 can be a communication apparatus configured to be communicable with the information terminal 20.

The crowdedness detector 17 detects the crowdedness in the shop. It is not essential to provide the crowdedness detector 17. The crowdedness detector 17 detects, for example, the number of customers in the shop. The crowdedness detector 17 can transmit crowdedness information related to the detected number of persons to the information processing apparatus 10. The crowdedness information is not limited to information on the number of persons itself, and it may be information indicating the crowdedness of the shop classified by level. The crowdedness detector 17 may employ any method that allows for detection of the crowdedness in the shop.

For example, the crowdedness detector 17 includes a camera installed at the entrance/exit of the shop and a processor. The crowdedness detector 17 can count the number of customers entering and leaving the shop from a camera image and calculate the number of persons in the shop.

Further, the crowdedness detector 17 may include a camera arranged at a position in the shop, such as on the ceiling, to provide a view of the inside of the shop, and a processor. In this case, the crowdedness detector 17 extracts humans from a camera image and calculates the number of persons in the shop. The crowdedness detector 17 may use the same camera and processor as those used in the second acquisition interface 16.

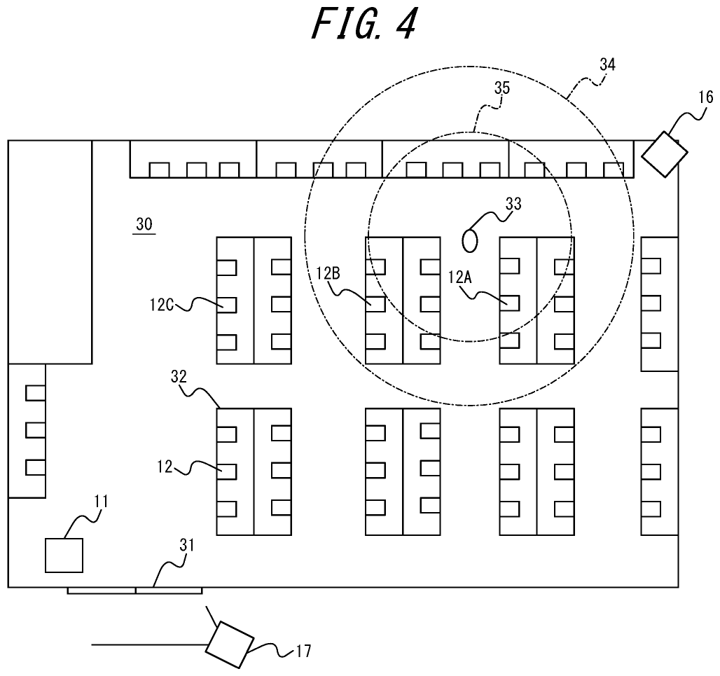

With reference to FIG. 4, a product indication method by the clothing indication system 1 will be described. FIG. 4 is a plan view illustrating an example of the shop 30 seen from above. FIG. 4 provides an example for illustrative purposes and does not limit the size and structure of the shop, the configuration and layout of the components, or the like to which the clothing indication system 1 of the present disclosure is applied.

The shop 30 illustrated in FIG. 4 has an entrance/exit 31 at one location. Customers enter and exit the shop 30 through this entrance/exit 31. In the shop 30, there is a plurality of product shelves 32 arranged for showing and displaying clothing items 13. In FIG. 4, only one of the plurality of product shelves 32 is denoted with a reference numeral. Illustration of the clothing items 13 is omitted in FIG. 4. Indicators 12 are attached to the respective clothing items 13. In FIG. 4, only some of the plurality of indicators 12 are denoted with reference numerals. The indicators 12 are arranged at positions visible from the outside of the shelves.

Although not illustrated in FIG. 4, one or more relays 14 may be installed in the shop 30. For example, a relay 14 may be installed on each product shelf 32. The relay 14 installed on each product shelf 32 may be configured to transmit a signal only to indicators 12 located within the product shelf 32.

In the vicinity of the entrance/exit 31 of the shop 30, a camera included in the crowdedness detector 17 is installed. The position at which the camera is installed may be outside or inside the shop 30. The camera is installed so that the imaging range covers the entrance/exit 31. The crowdedness detector 17 can detect a customer entering or leaving the shop 30 from an image captured by the camera and determine the number of customers in the shop 30 at all times.

The first acquisition interface 11 is installed in the vicinity of the entrance/exit of the shop 30. The first acquisition interface 11 may be, for example, in the form of a kiosk terminal or a robot that welcomes a customer. The first acquisition interface 11 has a communication interface capable of communicating with the information terminal 20 of a user 33 of the clothing indication system over a short distance. When entering the shop 30, the user 33 brings the information terminal 20 closer to the communication interface of the first acquisition interface 11, with an application running on the information terminal 20. Thus, body size information for the user 33 is transmitted from the information terminal 20 to the first acquisition interface 11. A shop operator may grant an incentive to the user 33, for example, by providing points of the point system, so that the user will willingly bring the information terminal 20 closer to the first acquisition interface 11 when visiting the shop.

Further, one or more cameras included in the second acquisition interface 16 are installed at one or more positions in the shop 30 in the vicinity of the ceiling. The second acquisition interface 16 determines the position of the user 33 from a camera image. The second acquisition interface 16 continuously tracks the position of the user 33 who enters through the entrance/exit 31. The second acquisition interface 16 transmits the current position of the user 33 as positional information to the information processing apparatus 10.

When the user 33 visits the shop and brings the information terminal 20 closer to the first acquisition interface 11, body size information for the user 33 is transmitted from the first acquisition interface 11 to the information processing apparatus 10. Based on the body size information, the information processing apparatus 10 selects clothing items 13 that fit the body size of the user 33 from among the plurality of clothing items 13 in the shop 30. Specifically, the controller 10b of the information processing apparatus 10 searches the memory 10c, which stores the plurality of clothing items 13, for clothing items 13 having their own clothing size information that matches the body size information for the user 33.

The information processing apparatus 10 causes the relay 14 to transmit, to each of the indicators 12 corresponding to the selected clothing items 13, a radio signal including identification information for the indicator 12. The controller 12c of each indicator 12 receives it via the antenna 12a and the radio processor 12b. In a case in which the identification information included in the received radio signal matches its own identification information, the controller 12c of each indicator 12 causes the light emitter 12d to emit light. Thus, the selected clothing items 13 are indicated to the user 33 in a manner such that they are distinguishable from other clothing items 13. This allows the user 33 to easily find clothing items 13 that fit their body size.

In an embodiment, the information processing apparatus 10 may select clothing items 13 to be indicated by the indicators 12 by considering positional information for the user 33 that is acquired using the second acquisition interface 16. For example, in a case in which the shop 30 is large, it is not effective to cause an indicator 12 to emit light if it corresponds to a clothing item 13 located out of sight of the user 33. The information processing apparatus 10 therefore selects only the clothing items 13 located in the vicinity of the user 33.

For example, the information processing apparatus 10 may cause only the indicators 12 corresponding to clothing item 13 located within a first distance range 34, which corresponds to a predetermined distance from the position of the user 33, to emit light. The first distance range 34 may be set, for example, within 5 m. As illustrated in FIG. 4, the information processing apparatus 10 can cause an indicator 12A and an indicator 12B, which are located within the first distance range 34, to emit light and can cause an indicator 12C, which is located outside the first distance range 34, not to emit light. The information processing apparatus 10 may decide whether to cause indicators 12 to emit light in units of each product shelf 32, instead of selecting individual indicators 12 based on distance from the user 33.

Further, the information processing apparatus 10 may select clothing items 13 to be indicated by the indicators 12, by considering crowdedness information related to the number of customers in the shop 30 that is detected by the crowdedness detector 17. For example, in a case in which there are a large number of customers in the shop 30, it may be difficult for the user 33 to see the light emitted by an indicator 12 located at a distance from the user 33. Further, when the shop 30 is crowded, the user 33 may feel uncomfortable about other customers seeing clothing items 13 that fit their body size. For this reason, the information processing apparatus 10 may select only the clothing items 13 that are located in a narrower range in the vicinity of the user 33.

For example, the information processing apparatus 10 may cause only the indicators 12 corresponding to clothing items 13 located within a second distance range 35, which is narrower than the first distance range 34 from the position of the user 33, to emit light. The second distance range 35 can be set in accordance with crowdedness information. The second distance range 35 can be set, for example, within 3 m. As illustrated in FIG. 4, for example, the information processing apparatus 10 can cause the indicator 12A, which is located within the second distance range 35, to emit light and can cause the indicator 12B and the indicator 12C, which are located outside the second distance range 35, not to emit light. By doing so, indication of clothing items 13 by the indicators 12 can be performed more efficiently. Further, it is prevented that the indicators 12 are seen by other customers who are not users of the clothing indication system 1, thus causing discomfort to the user 33 and the other customers.

To limit the range of clothing items 13 indicated to the user 33, the indicators 12 may be configured to be communicable with the information terminal 20 in the possession of the user 33 by short-range wireless communication. In this case, the information processing apparatus 10 does not select clothing items 13 to be indicated based on positional information for the user 33, but the controller 12c of each indicator 12 causes the light emitter 12d to emit light only when being connected to the information terminal 20 by short-range wireless communication. Accordingly, in this case, the second acquisition interface 16 for acquiring the position of the user 33 may be omitted.

In an embodiment, each indicator 12 can be capable of emitting visible light of a plurality of wavelengths. In other words, each indicator 12 can emit light in a plurality of colors. In a case in which there is a plurality of users 33 who use the clothing indication system 1 in the shop 30, the information processing apparatus 10 can assign a different color to each user 33. The information processing apparatus 10 may notify the user 33 of the color that is to be assigned to the user 33, upon communicating with the information terminal 20 using the first acquisition interface 11 when the user 33 enters the shop 30. For example, in a case in which the first acquisition interface 11 is a terminal having a display, the first acquisition interface 11 may display the color assigned to the user 33 on the display. By assigning a different color to each user 33, even in a case in which a plurality of users 33 is in the shop 30, each user 33 can identify clothing items 13 indicated to them by checking the color of the indicators 12.

Instead of emitting light in different colors, each light emitter 12d may emit visible light in different light-emitting patterns corresponding to different users 33. In this case, the light emitter 12d may repeatedly flash in different patterns so that each user 33 can identify it.

When selecting clothing items 13, the information processing apparatus 10 may consider attribute information for the user 33, in addition to body size information for the user 33. The attribute information may include age, hairstyle, skin tone, occupation, place of residence, preference of clothing, or the like of the user 33. The attribute information may, for example, be registered by the user 33 in advance in an application on the information terminal 20 and transmitted from the information terminal 20 to the first acquisition interface 11, together with the body size, when the user enters the shop 30. The information processing apparatus 10 may acquire part of the attribute information by image recognition using a camera installed in the shop 30.

For example, the information processing apparatus 10 may indicate to the user 33 only the clothing items 13 in a plurality of clothing items 13 to which the body size fits that are targeted for the age group of the user 33.

For example, the information processing apparatus 10 may select, from among a plurality of clothing items 13 to which the body size fits, clothing items 13 purchased at a high percentage by customers who have the same attribute information as that for the user 33, to be indicated to the user 33. The information processing apparatus 10 may indicate clothing items 13 that the user 33 may have a preference for, based on product information for each product that is stored in the memory 10c. The information processing apparatus 10 may be equipped with a system that infers clothing items 13 that the user 33 may have a preference for based on the attribute information. The information processing apparatus 10 may infer the preference of the user 33 using Artificial Intelligence (AI).

The attribute information for the user 33 may further include information on a preference of fashion of the user 33. The information on the preference of fashion of the user 33 may be registered by the user 33 in the application directly through the information terminal 20. The preference of fashion includes, for example, clothing categories, such as casual, classic, street, vintage, or chic. The information processing apparatus 10 may select products that suit the preference of the user 33 from among a plurality of clothing items 13 to which the body size fits based on the product information, and may indicate the selected products to the user 33.

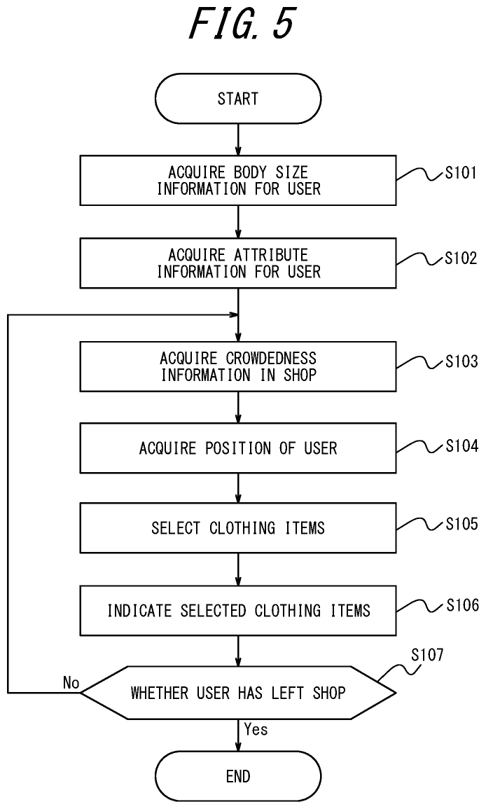

A processing flow of a clothing indication method executed by the information processing apparatus 10 will be described below with reference to FIG. 5. The method disclosed herein can be performed by a processor included in the information processing apparatus 10 according to a program. Such a program may be stored in a non-transitory computer readable medium. Examples of non-transitory computer readable media may include, but are not limited to, a hard disk, RAM, ROM, flash memory, a CD-ROM, an optical storage device, and a magnetic storage device.

The information processing apparatus 10 acquires body size information for the user 33 from the first acquisition interface 11, by the user 33 entering the shop 30 and bringing the information terminal 20 closer to the first acquisition interface 11 (Step S101). As a result, the information processing apparatus 10 recognizes that the user 33 has come to the shop 30. The information processing apparatus 10 manages information for the user 33 in subsequent steps. The body size information for the user 33 is stored in the memory 10c.

The information processing apparatus 10 further acquires, from the first acquisition interface 11, attribute information for the user 33 that is stored in the information terminal 20 (Step S102). The processing of Step S102 is not essential. The attribute information for the user 33 is stored in the memory 10c and managed along with the body size information for the user 33.

The information processing apparatus 10 acquires, from the crowdedness detector 17, crowdedness information in the shop 30 (Step S103).

The processing of Step S103 is not essential. The information processing apparatus 10 may periodically acquire crowdedness information. The information processing apparatus 10 may acquire crowdedness information when there is a customer entering or leaving the shop 30. Accordingly, the processing of Step S103 does not necessarily need to be performed before Step S104 and may be performed at any timing.

The information processing apparatus 10 acquires the position of the user 33 in the shop 30 from the second acquisition interface 16 (Step S104). The processing of Step S104 is not essential. The information processing apparatus 10 can acquire the position of the user 33 in the shop 30, for example, as coordinates on a two-dimensional plane along the floor of the shop 30.

The information processing apparatus 10 selects clothing items 13 to be indicated to the user 33, by considering body size information for the user 33 and, in some cases, positional information for the user 33, crowdedness information in the shop 30, and/or attribute information for the user 33 (Step S105). The information processing apparatus 10 may select all the clothing items 13 that match the body size information for the user 33. Based on the positional information for the user 33, the information processing apparatus 10 may select only the clothing items 13 that are located within a predetermined distance from the user 33 from among the clothing items 13 that match the body size information for the user 33. The information processing apparatus 10 may adjust the range of the predetermined distance from which clothing items 13 are selected, based on the crowdedness information. In a case in which there is a large number of customers in the shop 30 and it is crowded, the predetermined distance may be set to be short. Based on the attribute information for the user 33, the information processing apparatus 10 may select only the clothing items 13 that are presumed to suit the user 33.

The information processing apparatus 10 causes the corresponding indicators 12 to indicate the selected clothing items 13 in a manner such that they are distinguishable from other clothing items 13 (Step S106). For example, the information processing apparatus 10 causes the light emitters 12d of the indicators 12 to emit light.

When the user 33 leaves the shop 30, the information processing apparatus 10 acquires this information (Step S107). For example, when the second acquisition interface 16 tracks the user 33 and detects that the user 33 has left through the entrance/exit 31, the information processing apparatus 10 acquires this information from the second acquisition interface 16. In a case in which the user 33 has not left the shop 30 (Step S107: No), the information processing apparatus 10 returns to Step S103 and repeats the processing of this step and the subsequent steps. Accordingly, the information processing apparatus 10 continues to indicate clothing items 13 while the user 33 is in the shop 30. On the other hand, in a case in which the user 33 has left the shop 30 (Step S107: Yes), the information processing apparatus 10 ends the indication of clothing items 13 to the user 33.

In a case in which there is a plurality of users 33 in the shop 30, the aforementioned processing from Step S101 to Step S107 is performed for each user 33. In Step S106, the information processing apparatus 10 may change indication methods for products for different users 33. For example, the information processing apparatus 10 may change the wavelengths or light-emitting patterns of light emitted by light emitters 10d for different users 33.

As described above, the clothing indication system 1 of the present disclosure allows a user 33 to easily find clothing items 13 that fit the body size of the user 33 from among a large number of clothing items 13 displayed in the shop 30. Further, the clothing indication system 1 of the present disclosure allows for adjusting the range of clothing items 13 to be indicated, in accordance with the number of customers in the shop 30 and with the position of a user 33, thereby providing efficient indication of clothing items 13 to the user 33 so that they can be seen by the user 33. Furthermore, by considering attribute information, the clothing indication system 1 can perform indication of products to a user 33 as an expected purchaser of the clothing items 13, indication of clothing items 13 by inferring the preference of the user 33, or the like.

Although the embodiments of the present disclosure have been described based on the drawings and examples, the present disclosure is not limited to the above embodiments, and various modifications and revisions may be implemented. For example, functions or the like included in each means, each step, or the like can be rearranged without logical inconsistency, and a plurality of means, steps, or the like can be combined together or divided.

1. A clothing indication system, comprising:
a first acquisition interface configured to acquire body size information indicating a body size of a user;
a plurality of indicators provided in one-to-one correspondence with a plurality of clothing items displayed in a shop, the plurality of indicators being configured to indicate some clothing items selected from among the plurality of clothing items in a manner such that the selected clothing items are distinguishable from other clothing items; and
an information processing apparatus configured to select the clothing items to be indicated by the plurality of indicators based on the body size information for the user.

2. The clothing indication system according to claim 1, further comprising
a second acquisition interface configured to acquire a position of the user in the shop, wherein
the information processing apparatus is configured to select the clothing items to be indicated by the plurality of indicators, by considering positional information indicating the position acquired by the second acquisition interface, in addition to the body size information.

3. The clothing indication system according to claim 2, wherein
the information processing apparatus is configured to select clothing items located within a predetermined distance range from the position of the user in the shop as the clothing items to be indicated by the plurality of indicators.

4. The clothing indication system according to claim 2, further comprising
a crowdedness detector configured to detect the number of customers in the shop, wherein
the information processing apparatus is configured to select the clothing items to be indicated by the plurality of indicators, by considering crowdedness information related to the number of customers detected by the crowdedness detector, in addition to the body size information and the positional information.

5. The clothing indication system according to claim 1, wherein
each indicator in the plurality of indicators includes a light emitter configured to emit visible light.

6. The clothing indication system according to claim 5, wherein
each indicator in the plurality of indicators is configured to emit visible light of different wavelengths for different users.

7. The clothing indication system according to claim 5, wherein
each indicator in the plurality of indicators is configured to emit visible light in different light emission patterns for different users.

8. The clothing indication system according to claim 1, wherein
the first acquisition interface is configured to acquire attribute information including age, hairstyle, skin tone, occupation, place of residence, and/or preference of clothing of the user, and the information processing apparatus is configured to select the clothing items to be indicated by the plurality of indicators, by considering the attribute information.

9. An information processing apparatus comprising:
a communication interface configured to receive body size information indicating a body size of a user; and
a controller configured to select some clothing items from among a plurality of clothing items displayed in a shop based on the body size information for the user and to cause, via the communication interface, a plurality of indicators provided in one-to-one correspondence with the plurality of clothing items to indicate the selected clothing items in a manner such that the selected clothing items are distinguishable from other clothing items.

10. The information processing apparatus according to claim 9, wherein
the communication interface is configured to acquire positional information indicating a position of the user in the shop, and the information processing apparatus is configured to select the clothing items to be indicated by the plurality of indicators, by considering the positional information, in addition to the body size information.

11. The information processing apparatus according to claim 10, wherein
the controller is configured to select clothing items located within a predetermined distance range from the position of the user in the shop as the clothing items to be indicated by the plurality of indicators.

12. The information processing apparatus according to claim 10, wherein
the communication interface is configured to acquire crowdedness information related to the number of customers in the shop, and the controller is configured to select the clothing items to be indicated by the plurality of indicators, by considering the crowdedness information, in addition to the body size information and the positional information.

13. The information processing apparatus according to claim 9, wherein
each indicator in the plurality of indicators includes a light emitter configured to emit visible light.

14. The information processing apparatus according to claim 13, wherein
the controller is configured to control each indicator in the plurality of indicators to emit visible light of different wavelengths for different users.

15. The information processing apparatus according to claim 13, wherein
the controller is configured to control each indicator in the plurality of indicators to emit visible light in different light emission patterns for different users.

16. The information processing apparatus according to claim 9, wherein
the communication interface is configured to acquire attribute information including age, hairstyle, skin tone, occupation, place of residence, and/or preference of clothing of the user, and the controller is configured to select the clothing items to be indicated by the plurality of indicators, by considering the attribute information.

17. A clothing indication method, comprising:
acquiring body size information indicating a body size of a user;
selecting, by an information processing apparatus, some clothing items from among a plurality of clothing items displayed in a shop based on the body size information for the user; and
indicating the selected clothing items in a manner such that the selected clothing items are distinguishable from other clothing items using a plurality of indicators provided in one-to-one correspondence with the plurality of clothing items.

18. The clothing indication method according to claim 17, further comprising
acquiring a position of the user in the shop, wherein
the selecting comprises selecting, by the information processing apparatus, the clothing items to be indicated by the plurality of indicators from among the plurality of clothing items, by considering positional information indicating the position in the shop, in addition to the body size information.

19. The clothing indication method according to claim 18, wherein
the selecting comprises selecting, by the information processing apparatus, clothing items located within a predetermined distance range from the position of the user in the shop as the clothing items to be indicated by the plurality of indicators.

20. The clothing indication method according to claim 18, further comprising
detecting the number of customers in the shop, wherein
the selecting comprises selecting, by the information processing apparatus, the clothing items to be indicated by the plurality of indicators, by considering crowdedness information related to the number of customers, in addition to the body size information and the positional information.
